(19) United States
(12) Patent Application Publication
(10) Pub. No.: US 2026/0211446 A1
(43) Pub. Date: Jul. 23, 2026

(54) OPERATING DEVICE AND ACOUSTIC DEVICE

(71) Applicant: AlphaTheta Corporation, Yokohama-shi, Kanagawa (JP)

(72) Inventors: Katsuhiro Shiba, Yokohama-shi, Kanagawa (JP); Nao Takagi, Yokohama-shi, Kanagawa (JP)

(21) Appl. No.: 19/142,680

(22) PCT Filed: Dec. 26, 2022
(86) PCT No.: PCT/JP2022/047833

§ 371 Date: Jun. 24, 2025

(51) Int. Cl. G05G 1/10; H01H 19/11; H01H 19/14; H01H 19/20; H04R 3/00

(52) U.S. Cl. CPC G05G 1/10; G05G 5/03; G05G 5/06; H01H 3/08; H01H 19/11; H01H 19/14; H01H 19/20; H01H 2215/028

(57) ABSTRACT

An operation device includes: a rotary member; a sleeve member including at least one of a convex portion or a concave portion, the sleeve member being engaged with the rotary member that is inserted through the sleeve member, the convex portion protruding away from a rotation axis of the rotary member in a first direction, the concave portion being recessed toward the rotation axis in the first direction, the first direction being orthogonal to the rotation axis; a latch member provided near an outer circumference of the sleeve member with respect to the rotation axis, the latch member including at least one latch portion located at a position capable of facing the at least one of the convex portion or the concave portion; and a pressing unit configured to press the latch member against the sleeve member.

### TECHNICAL FIELD

The present invention relates to an operation device and an acoustic device.

### BACKGROUND ART

An operation device having a rotary member has been used in various devices. For instance, an amplifier disclosed in Non-Patent Literature 1 includes an operation knob that is capable of adjusting a plurality of factors by itself for the purpose of space-saving and the like.

### CITATION LIST

### Non-Patent Literature(s)

Non-Patent Literature 1: Product introduction homepage of THR (manufactured by Yamaha Corporation); (https://jp.yamaha.com/products/musical_instruments/guitars_basses/amps_accessories/thr/index.html)

### SUMMARY OF THE INVENTION

### Problem(s) to be Solved by the Invention

There are various demands for operation devices having a rotary member in accordance with usage thereof. For instance, many requests regarding operational feeling and operability arise from users (e.g. a DJ) of an operation device used for acoustic devices.

An object of the invention is to provide an operation device exhibiting favorable operational feeling and excellent operability in accordance with the purpose of the operation, and an acoustic device including the operation device.

### Means for Solving the Problem(s)

[1] An operation device including: a rotary member; a sleeve member including at least one of a convex portion or a concave portion, the sleeve member being engaged with the rotary member that is inserted through the sleeve member, the convex portion protruding away from a rotation axis of the rotary member in a first direction, the concave portion being recessed toward the rotation axis in the first direction, the first direction being orthogonal to the rotation axis; a latch member provided near an outer circumference of the sleeve member with respect to the rotation axis, the latch member including at least one latch portion located at a position capable of facing the at least one of the convex portion or the concave portion; and a pressing unit configured to press the latch member against the sleeve member.
[2] The operation device according to [1], where the pressing unit includes a resilient member.
[3] The operation device according to [1] or [2], where the sleeve member is rotatable integrally with the rotary member.
[4] The operation device according to any one of [1] to [3], where the sleeve member includes a plurality of the convex portions and a plurality of the concave portions at a side face in a circumferential direction of the rotation axis.
[5] The operation device according to any one of [1] to [4], further including: an operation knob covering the rotary member, where the at least one of the convex portion or the concave portion is located at a position corresponding to an adjustment content that is to be achieved through an operation on the operation knob.
[6] The operation device according to any one of [1] to [5], further including: a switcher configured to switch between a first state where the sleeve member and the latch member are capable of contact with each other, and a second state where the sleeve member and the latch member are not in contact with each other.
[7] The operation device according to [6], where the adjustment content includes a stepwise adjustment, and the sleeve member includes one or more of the concave portion at a position corresponding to a stage of the adjustment.
[8] The operation device according to [6], where the adjustment content includes an adjustment relating to a plurality of factors, and the sleeve member includes one or more of the convex portion at a position corresponding to a border between the plurality of factors.
[9] An acoustic device including the operation device according to any one of [1] to [8].

### BRIEF DESCRIPTION OF DRAWINGS

FIG. 1 schematically illustrates an exterior of an operation device according to a first exemplary embodiment of the invention.

FIG. 2 is a perspective view illustrating a structure of the operation device according to the first exemplary embodiment of the invention.

FIG. 3 schematically illustrates a relative positional relationship between a sleeve member and a latch member.

FIG. 4 schematically illustrates a profile of the sleeve member and the latch member.

FIG. 5A schematically illustrates another example of the sleeve member and the latch member.

FIG. 5B schematically illustrates the other example of the sleeve member and the latch member.

FIG. 6A schematically illustrates still another example of the sleeve member and the latch member.

FIG. 6B schematically illustrates the still another example of the sleeve member and the latch member.

FIG. 7A schematically illustrates a structure of an operation device according to a second exemplary embodiment of the invention.

FIG. 7B schematically illustrates the structure of the operation device according to the second exemplary embodiment of the invention.

### DESCRIPTION OF EMBODIMENT(S)

### First Exemplary Embodiment

A first exemplary embodiment of the invention will be described below with reference to the attached drawings.

### Configuration of Operation Device

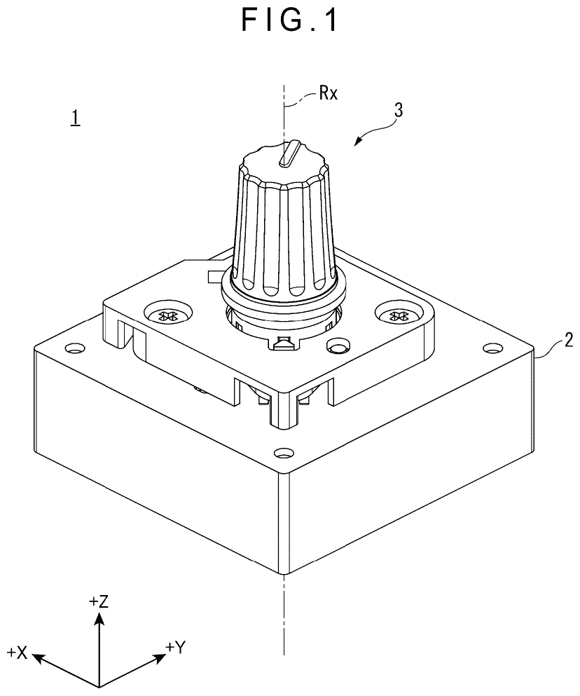

FIG. 1 schematically illustrates an exterior of an operation device 1 according to the present exemplary embodiment.

As illustrated in FIG. 1, the operation device 1 includes a housing 2 and an operation unit 3 provided on the housing 2. The operation device 1 is configured to receive a user's operation on the operation unit 3.

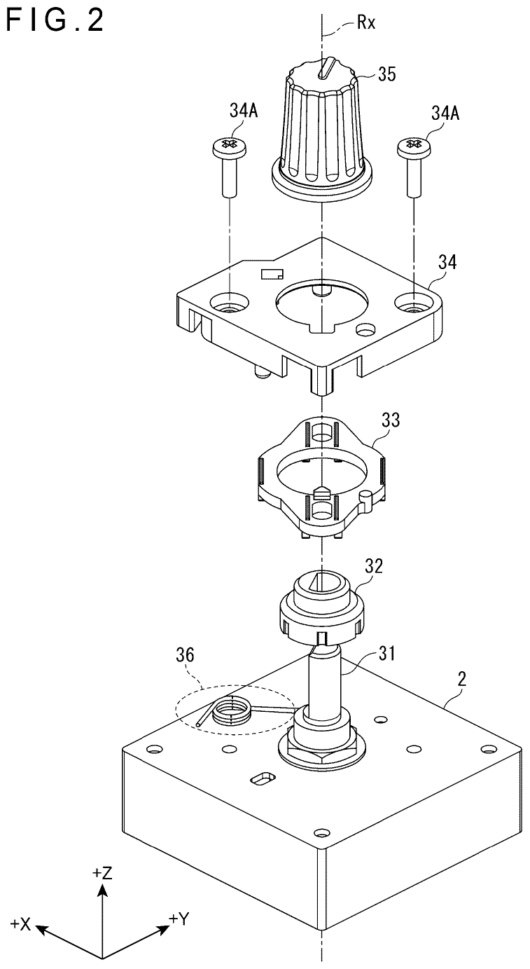

FIG. 2 is a perspective view illustrating a structure of the operation device 1. As illustrated in FIG. 2, the operation unit 3 includes a shaft 31 in a form of a rotary member, a sleeve member 32 engaged with the shaft 31 to be integrally rotatable with the shaft 31, a latch member 33 provided near an outer circumference of the sleeve member 32, a casing 34 covering the sleeve member 32 and the latch member 33, an operation knob 35 covering the shaft 31, and a pressing unit 36 configured to press the latch member 33 against the sleeve member 32.

Hereinafter, mutually orthogonal three directions are defined as an X direction, a Y direction, and a Z direction. Among these directions, the Z direction is a direction along a rotation axis Rx of the shaft 31. The X and Y directions are orthogonal to each other and are each orthogonal to the rotation axis Rx of the shaft 31.

The sleeve member 32 is engaged with the shaft 31 that is inserted through the sleeve member 32. Further, the sleeve member 32 has at least one of a convex portion or a concave portion on a side face thereof. Details of the sleeve member 32 will be described later.

The latch member 33, which is provided near the outer circumference of the sleeve member 32 with respect to the shaft 31, includes at least one latch portion located at a position capable of facing at least one of the above-described convex portion or concave portion of the sleeve member 32. Details of the latch member 33 will be described later.

The casing 34, which houses the sleeve member 32 and the latch member 33 thereinside, is fixed to the housing 2 with screws 34A.

The pressing unit 36 includes a resilient member (e.g. a spring) and configured to press the latch member 33 against the sleeve member 32.

### Configurations of Sleeve Member and Latch Member

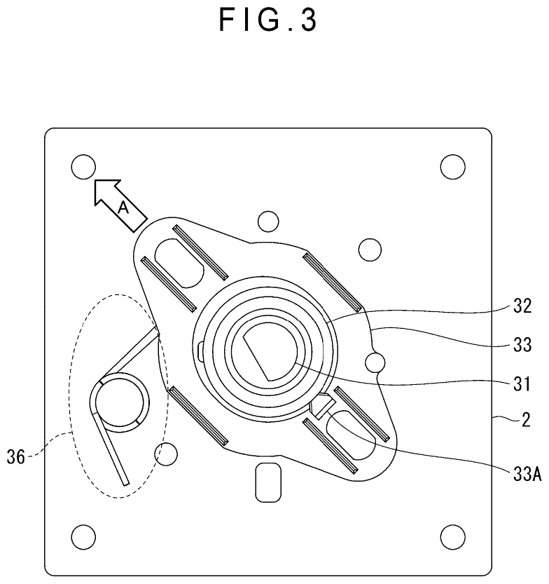

FIG. 3 schematically illustrates a relative positional relationship between the sleeve member 32 and the latch member 33.

As illustrated in FIG. 3, the latch member 33 includes a latch portion 33A located at a position capable of facing at least one of the convex portion(s) or concave portion(s) of the sleeve member 32. The latch member 33 is pressed against the sleeve member 32 in a direction indicated by an arrow A by the pressing unit 36. A fixing unit (not illustrated) for fixing an end of the resilient member (e.g. a spring) may be provided to the casing 34 or, alternatively, to the housing 2.

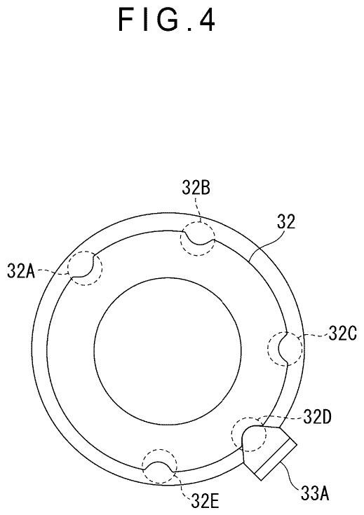

FIG. 4 schematically illustrates a profile of the sleeve member 32 and the latch member 33.

As illustrated in FIG. 4, the sleeve member 32 includes a plurality of concave portions 32A to 32E on the side face thereof. The concave portions 32A to 32E each have a shape recessed toward the rotation axis Rx in a first direction orthogonal to the rotation axis Rx of the shaft 31, more specifically, in a direction from the side face of the sleeve member 32 toward the rotation axis Rx of the shaft 31, i.e., recessed toward a center of the sleeve member 32.

When the operation knob 35 of the operation unit 3 is operated by a user, the shaft 31 and the sleeve member 32 are integrally rotated. At this time, the latch member 33 is pressed against the sleeve member 32 as described above, and therefore, when the latch portion 33A of the latch member 33 faces one of the concave portions 32A to 32E of the sleeve member 32, the latch portion 33A is engaged with the facing one of the concave portions. In an example illustrated in FIG. 4, the latch portion 33A exemplarily faces the concave portion 32D of the sleeve member 32 to be engaged with the facing concave portion 32D.

When the latch portion 33A of the latch member 33 is engaged with one of the concave portions 32A to 32E of the sleeve member 32, so-called clicking feeling is given to a user operating the operation knob 35.

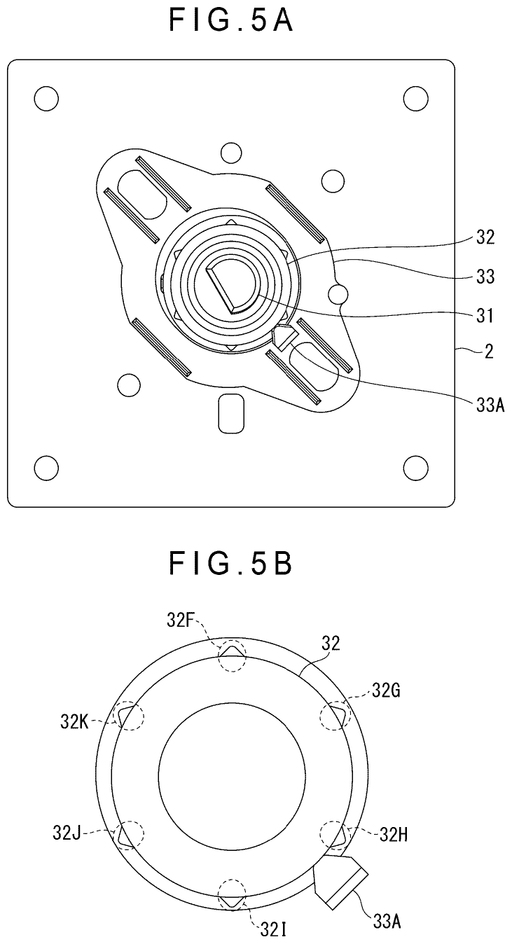

FIGS. 5A and 5B schematically illustrate another example of the sleeve member 32 and the latch member 33.

In the example illustrated in FIGS. 5A and 5B, the sleeve member 32 includes a plurality of convex portions 32F to 32K on the side face in a circumferential direction thereof. The convex portions 32F to 32K each have a shape protruding in the first direction orthogonal to the rotation axis Rx of the shaft 31, more specifically, in a direction from the side face of the sleeve member 32 away from the rotation axis Rx of the shaft 31, i.e. protruding from the sleeve member 32 in an outward direction.

When the operation knob 35 of the operation unit 3 is operated by a user and the latch portion 33A of the latch member 33 faces one of the convex portions 32F to 32K of the sleeve member 32, the latch portion 33A is moved to climb over the facing one of the convex portions.

When the latch portion 33A of the latch member 33 is moved to climb over one of the convex portions 32F to 32K of the sleeve member 32, resistance is given to a user operating the operation knob 35 in contrast to the clicking feeling.

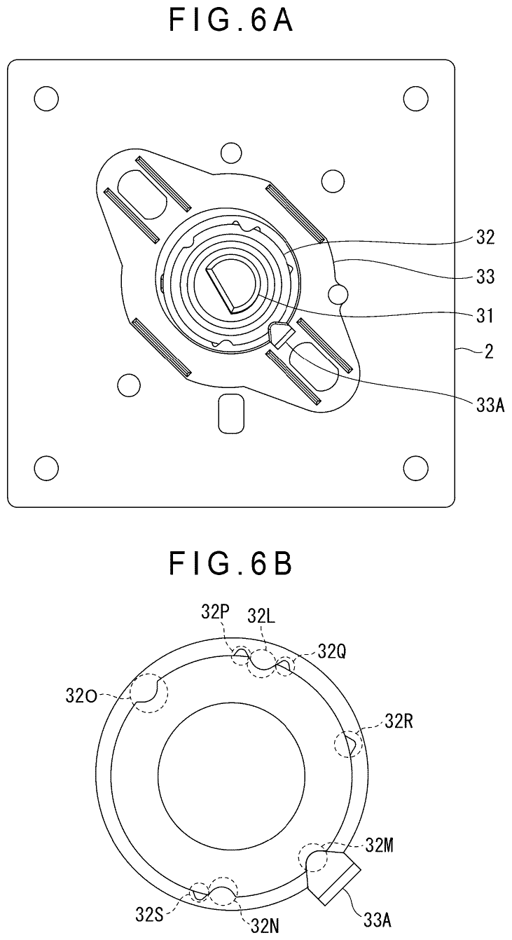

FIGS. 6A and 6B schematically illustrate still another example of the sleeve member 32 and the latch member 33.

In the example illustrated in FIGS. 6A and 6B, the sleeve member 32 includes a plurality of concave portions 32L to 320 and a plurality of convex portions 32P to 32S on the side face thereof.

When the operation knob 35 of the operation unit 3 is operated by a user and the latch portion 33A of the latch member 33 faces one of the concave portions 32L to 320 of the sleeve member 32, the latch portion 33A is engaged with the facing one of the concave portions. In the example illustrated in FIGS. 6A and 6B, the latch portion 33A exemplarily faces the concave portion 32M of the sleeve member 32 to be engaged with the facing concave portion 32M.

In contrast, when the latch portion 33A of the latch member 33 faces one of the convex portions 32P to 32S of the sleeve member 32, the latch portion 33A is moved to climb over the facing one of the convex portions.

As a result, when the latch portion 33A of the latch member 33 is engaged with one of the concave portions 32L to 320 of the sleeve member 32, clicking feeling is given to a user operating the operation knob 35, whereas, when the latch portion 33A of the latch member 33 is moved to climb over one of the convex portions 32P to 32S of the sleeve member 32, resistance is given to the user operating the operation knob 35.

As described above, the operational feeling can be controlled in response to a user's operation on the operation knob 35 by the presence of the convex portion(s) and the concave portion(s) provided on the side face of the sleeve member 32. In view of the above, at least one of the convex portion(s) or the concave portion(s) is provided on the sleeve member 32 at a position corresponding to an adjustment content that is to be achieved through the user's operation on the operation knob 35.

As a first example, it is assumed that the adjustment content by the operation knob 35 includes stepwise adjustment. In this case, it is preferable that at least one concave portion is provided on the side face of the sleeve member 32 at a position corresponding to a stage of the adjustment.

For instance, as exemplarily illustrated in FIGS. 3 and 4, when the sleeve member 32 includes the plurality of concave portions 32A to 32E, the plurality of concave portions 32A to 32E are located at positions corresponding to respective stages of the adjustment to be tuned by the operation knob 35, thereby assisting the user's operation to a target position. Accordingly, by providing the concave portions on the sleeve member 32 each at a position where the operation of the operation knob 35 is desired or at a recommended position, the operation device 1 suitable for the adjustment content by the operation knob 35 can be provided.

As a second example, it is assumed that the adjustment content by the operation knob 35 includes adjustment relating to a plurality of factors. In this case, it is preferable that the convex portions are provided on the side face of the sleeve member 32 at positions corresponding to respective borders between the plurality of factors.

For instance, when the sleeve member 32 includes the plurality of convex portions 32F to 32K as illustrated in FIGS. 5A and 5B, adjustment for a first factor is assigned to a section between the convex portions 32F and 32G, and, similarly, adjustments for second, third, fourth, fifth, and sixth factors are respectively assigned to a section between the convex portions 32G and 32H, a section between the convex portions 32H and 321, a section between the convex portions 321 and 32J, a section between the convex portions 32J and 32K, and a section between the convex portions 32K and 32F, so that operability for adjusting each of the factors can be improved.

When the above-described plurality of convex portions 32F to 32K are not provided, a user, who operates the operation knob 35 for making an adjustment, has to visually check the position of the operation knob 35 relative to an indicating line provided on a surface of the housing 2 by printing or the like to determine each border between the factors. Further, it sometimes occurs that the border between the factors are erroneously crossed, resulting in incorrect operation. In contrast, when the convex portion(s) is provided at a position corresponding to the border between the plurality of factors, a user operating the operation knob 35 for adjustment can intuitively recognize the border between the factors by feeling resistance at the border between the factors. Accordingly, by providing the convex portion(s) on the sleeve member 32 at a position where the operation of the operation knob 35 is not desired or at a position where easy passing through of the operation knob 35 is not desired, a physical border or a blocking structure can be provided, so that the operation device 1 suitable for the adjustment content by the operation knob 35 can be provided.

### Advantage(s) of First Exemplary Embodiment

The following advantages can be achieved by the operation device 1 according to the above-described exemplary embodiment.

The operation device 1 includes: the shaft 31 in a form of a rotary member; the sleeve member 32 including at least one of the convex portion protruding away from the shaft 31 in the first direction orthogonal to the rotation axis Rx of the shaft 31 or the concave portion recessed toward the rotation axis Rx in the first direction, and being engaged with the shaft 31 that is inserted through the sleeve member 32; the latch member 33 provided near the outer circumference of the sleeve member 32 with respect to the rotation axis Rx and including at least one latch portion 33A located at a position capable of facing the at least one of the convex portion or the concave portion; and the pressing unit 36 configured to press the latch member 33 against the sleeve member 32.

According to the above arrangement, favorable operational feeling and excellent operability can be achieved in accordance with the purpose of the operation. Especially, with the use of the sleeve member 32 including the convex portion(s) and/or the concave portion(s) whose number and location are determined in accordance with the adjustment content by the operation knob 35, variety of patterns of operation contents and excellent operability can be easily achieved. Accordingly, detection and operability of the adjustment content can be changed in various patterns only by exchanging the sleeve member 32, so that design freedom of the operation device can be enhanced.

The convex portion(s) and/or the concave portion(s) of the sleeve member 32 are each provided at a position corresponding to the adjustment content that is to be achieved through the operation on the operation knob 35.

According to the above arrangement, the operation device 1 suitable for the adjustment content by the operation knob 35 can be provided.

The adjustment content by the operation knob 35 includes a stepwise adjustment and the sleeve member 32 includes at least one concave portion at a position corresponding to the stage of the adjustment.

According to the above arrangement, by providing the concave portion(s) at a position where the operation of the operation knob 35 is desired or at a recommended position, a user's operation to a specific position can be promoted and assisted.

Alternatively or additionally, the adjustment content by the operation knob 35 includes an adjustment relating to a plurality of factors and the sleeve member 32 includes at least one convex portion at a position corresponding to the border between the plurality of factors.

According to the above arrangement, by providing the convex portion(s) at a position where the operation of the operation knob 35 is not desired or at a position where easy passing through of the operation knob 35 is not desired, a physical border or a blocking structure can be provided.

### Second Exemplary Embodiment

A second exemplary embodiment of the invention will be described below with reference to the attached drawings. In the second exemplary embodiment, components having substantially the same function(s) and structure(s) as those in the first exemplary embodiment will be denoted by the same reference codes, omitting repetition of description thereof.

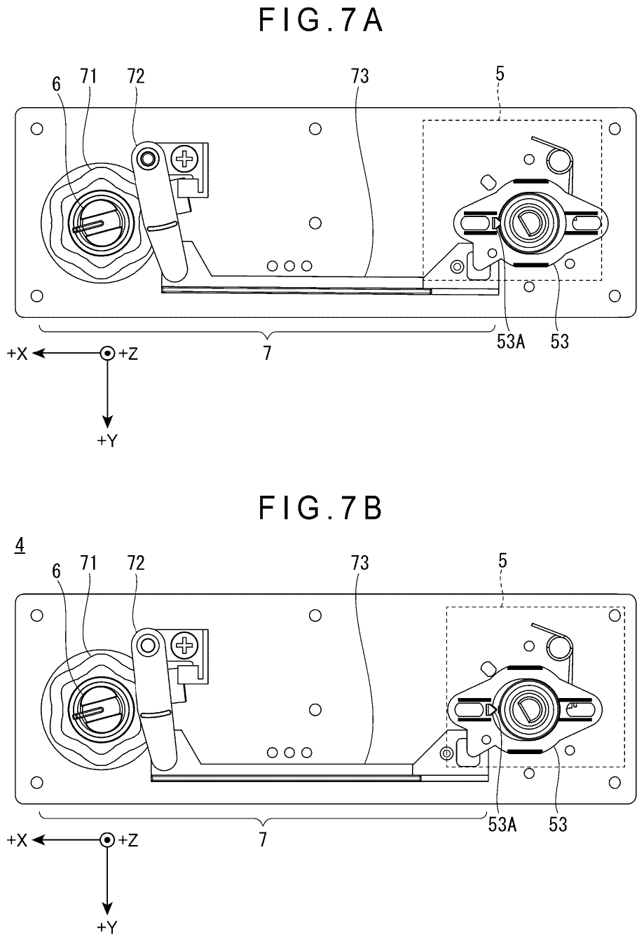

FIGS. 7A and 7B schematically illustrate an operation device 4 according to the second exemplary embodiment.

As illustrated in FIGS. 7A and 7B, the operation device 4 according to the present exemplary embodiment includes an operation device 5 similar to the operation device 1 of the first exemplary embodiment, a selector knob 6 for selecting an adjustment content by the operation device 5, and a switcher 7.

The operation device 5 according to the present exemplary embodiment has the same components and functions as those in the operation device 1 according to the first exemplary embodiment except that a latch member 53 including a latch portion 53A similar to the latch portion 33A is provided, in place of the latch member 33 described in the first exemplary embodiment.

The selector knob 6 is an operator provided with a rotary member for selecting the adjustment content by the operation device 5.

The switcher 7 is a link mechanism physically connecting the operation device 5 to the selector knob 6. The switcher 7 includes an on-off cam 71 rotatable integrally with the selector knob 6, a follower member 72 movable in conjunction with the on-off cam 71, and a link 73 connecting the follower member 72 to the latch member 53.

When the selector knob 6 is operated by a user, the on-off cam 71 is rotated in accordance with a rotational position of the selector knob 6 to cause the follower member 72 to move the link 73 in a +X direction or a-X direction.

For instance, when the link 73 is moved in the-X direction as illustrated in FIG. 7A, the latch member 53 connected to the link 73 is also moved in the-X direction. As a result, the latch portion 53A of the latch member 53 is capable of mutual contact with the sleeve member 32 (a first state).

In contrast, when the link 73 is moved in the +X direction as illustrated in FIG. 7B, the latch member 53 connected to the link 73 is also moved in the +X direction. As a result, the latch portion 53A of the latch member 53 is not in mutual contact with the sleeve member 32 (a second state).

As described above, the switcher 7 is configured to switch between the first state where the sleeve member 32 and the latch member 53 are capable of contact with each other, and the second state where the sleeve member 32 and the latch member 53 are not in contact with each other, in accordance with the adjustment content by the operation device 5 as selected by the selector knob 6.

With the use of the on-off cam 71, switching is appropriately performed between an arrangement where the sleeve member 32 and the latch member 53 are capable of contact with each other to apply clicking feeling and/or resistance on the operational feeling of the operation device 5 and an arrangement where the sleeve member 32 and the latch member 53 are not in contact with each other to apply neither clicking feeling nor resistance on the operational feeling of the operation device 5. Accordingly, operability can be further enhanced.

For instance, when the selector knob 6 is an effect selector for selecting effect(s) to be applied to an acoustic device, the selector knob 6 can switch the effects in accordance with the type of effect selected by the selector knob 6. With regard to, for instance, factors that are desired to be set by the operation device 5 in a stepwise manner (e.g., delay, echo, and roll) with reference to a tempo of a music piece, clicking feeling and/or resistance can be applied to the operational feeling of the operation device 5 by switching to the first state. In contrast, with regard to factors that are desired to be adjusted in a stepless manner, deterioration in operability caused by the clicking feeling and/or the resistance can be avoided by switching to the second state.

### Advantage(s) of Second Exemplary Embodiment

In addition to the same advantages achieved by the operation device 1 according to the first exemplary embodiment, the following advantage can be achieved by the operation device according to the above-described second exemplary embodiment.

The operation device includes the switcher 7 configured to switch between the first state and the second state, where the sleeve member 32 and the latch member 53 are capable of contact with each other and are not in contact with each other, respectively.

According to the above arrangement, favorable operational feeling can be easily switchably selected depending on an objective and usage and the operability can be improved.

### Modification(s) of Exemplary Embodiments

The invention is not limited to the above-described exemplary embodiments but includes modifications, improvements, and the like as long as the object of the invention can be achieved.

The convex portion(s) and the concave portion(s) on the sleeve member 32 described in the above exemplary embodiments are not necessarily arranged as in the above exemplary embodiments. Only one or both of the convex portion(s) and the concave portion(s) may be provided. The number and location of the convex portion(s) and the concave portion(s) are not limited to those in the exemplary embodiments. For instance, in the example illustrated in FIGS. 6A and 6B, the convex portions 32P and 32Q are adjacently located across the concave portion 32L, the convex portion 32S is adjacently located on one side of the concave portion 32N, and the rest of the convex portion and the concave portions are independently located. A plurality of the convex portions and the concave portions may be adjacently located or dispersedly located on the sleeve member 32.

The shape of the convex portions and the concave portions on the sleeve member 32 described in the above exemplary embodiments are not limited to those illustrated in the examples of the exemplary embodiments. For instance, the convex portions and the concave portions, which are exemplarily line-symmetric with respect to a diameter direction of the sleeve member 32, may be asymmetric. Further, the cross sections of the convex portions and the concave portions, which are exemplarily V-shaped or U-shaped in the exemplary embodiments, may be rectangular, circular, or ellipsoidal.

The switcher 7 described in the above second exemplary embodiment is merely exemplary and is not limited thereto. For instance, the switcher may connect a plurality of selector knobs to a single operation device. Alternatively or additionally, the switcher may be configured to be electronically controlled to achieve connection and switching.

The operation device described in each of the above exemplary embodiments is applicable to any devices. For instance, the operation device of the invention is similarly applicable also to an acoustic device in a form of DJ equipment including a rotary member (e.g., a mixer and a DJ controller). Further, the operation device of the invention is similarly applicable also to various devices other than DJ equipment, such as various controllers and toys.

The operation device including the rotary member rotatable about a vertical rotation axis is exemplarily described in the above exemplary embodiments. However, the invention is similarly applicable also to an operation device including a rotary member rotatable about a horizontal rotation axis and an operation device including rotary member rotatable about a rotation axis in other directions.

Suitable exemplary embodiments of the invention have been detailed above with reference to the attached drawings. However, the scope of the invention is not limited by the exemplary embodiments. It would be apparent for those skilled in the art to which the invention pertains that various modifications and revisions are conceivable within the technical idea described within the appended claims, and it is understood that such modifications and revisions are naturally within the technical scope of the invention.

### EXPLANATION OF CODES

1, 4, 5 . . . operation device, 2 . . . housing, 3 . . . operation unit, 6 . . . selector knob, . . . switcher, 31 . . . shaft, 32 . . . sleeve member, 33, 53 . . . latch member, 33A, 53A . . . latch portion, 34 . . . casing, 35 . . . operation knob, 36 . . . pressing unit

1-9. (canceled)

10. An operation device comprising:
a first operator configured to set a first adjustment content;
a second operator configured to set a second adjustment content that is different from the first adjustment content; and
a switcher connected to the first operator and the second operator, and configured to switch operational feeling of the first operator in conjunction with the second operator.

11. The operation device according to claim 10, wherein
the first operator includes
a rotary member configured to receive an operation,
a sleeve member including an engagement portion and being rotatable around a first rotation axis in accordance with rotation of the rotary member, the engagement portion including at least one of a convex portion protruding away from the first rotation axis in a first direction or a concave portion recessed toward the first rotation axis in the first direction, the first direction being orthogonal to the first rotation axis, and
a latch member including a latch portion engageable with the engagement portion, and provided near an outer side of the sleeve member, and
the switcher is configured to switch between a first state and a second state, in the first state the switcher being configured to move the latch member toward the sleeve member so that the engagement portion and the latch portion is capable of contact with each other, in the second state the switcher being configured to move the latch member away from the sleeve member so that the engagement portion and the latch portion are not in contact with each other.

12. The operation device according to claim 11, wherein
the second operator is a rotary operator rotatable around a second rotation axis, and
the switcher includes
a first connector configured to move in conjunction with the second operator,
a second connector connected to the latch member, and
a third connector configured to move the second connector according to movement of the first connector so that the latch member is moved toward or away from the sleeve member.

13. The operation device according to claim 12, wherein
the first connector is a cam member rotatable integrally with the second operator.

14. The operation device according to claim 13, wherein
the third connector is a follower member configured to move the latch member connected to the second connector toward or away from the sleeve member when the first connector is rotated

15. The operation device according to claim 13, wherein
the cam member is provided around the second operator and is rotatable around the second rotation axis integrally with the second operator.

16. The operation device according to claim 12, wherein
the second connector is a link connected to the latch member.

17. The operation device according to claim 11, wherein
the rotary member is inserted through the sleeve member, and
the latch member is provided near an outer circumference of the sleeve member with respect to the first rotation axis.

18. The operation device according to claim 11, further comprising:
a pressing unit configured to press the latch member against the sleeve member, wherein
the pressing unit includes a resilient member.

19. The operation device according to claim 11, wherein
the engagement portion includes the convex portion and the concave portion provided on a side face of the sleeve member along a circumferential direction of the first rotation axis.

20. The operation device according to claim 11, further comprising:
an operation knob covering the rotary member, wherein
the engagement portion is located at a position corresponding to the first adjustment content that is to be achieved through an operation on the operation knob.

21. The operation device according to claim 11, wherein
the engagement portion includes the concave portion,
the first adjustment content includes a stepwise adjustment, and
the concave portion is provided at a position corresponding to a stage of the adjustment.

22. The operation device according to claim 11, wherein
the engagement portion includes the convex portion,
the first adjustment content includes an adjustment relating to a plurality of factors, and
the convex portion is provided at a position corresponding to a border between the plurality of factors.

23. The operation device according to claim 10, wherein
the second adjustment content is selection of an effect to be applied to a music piece, and
the first adjustment content is an adjustment of a factor relating to the effect selected by the second operator.

24. An acoustic device comprising the operation device according to claim 10.
